(19) United States
(12) Patent Application Publication
(10) Pub. No.: US 2025/0012648 A1
(43) Pub. Date: Jan. 9, 2025

(54) Force Sensing Device

(71) Applicant: Peratech IP Ltd., Catterick Garrison (GB)

(72) Inventors: Daniel WHITING, Catterick Garrison (GB); Timothy Peter Wiles, Catterick Garrison (GB)

(21) Appl. No.: 18/887,261

(22) Filed: Sep. 17, 2024

Related U.S. Application Data
(63) Continuation of application No. PCT/GB2023/000015, filed on Mar. 17, 2023.

(30) Foreign Application Priority Data
Mar. 17, 2022 (GB) 2203737.8

(51) Int. Cl. G01L 1/26; G01L 1/20; G01L 25/00

(52) U.S. Cl. CPC G01L 1/26; G01L 1/205; G01L 25/00

(57) ABSTRACT

A force sensing device comprises a first electrode and a second electrode arranged to provide an electrical output in response to an applied force to determine the magnitude of the applied force. The force sensing device comprises a collapsible structure configured to provide an electrical short circuit in response to the applied force when the applied force exceeds a predetermined magnitude.

### CROSS REFERENCE TO RELATED APPLICATIONS

This application is a continuation of and claims priority to International Patent Application number PCT/GB2023/000015, filed on 17 Mar. 2023, which claims priority from United Kingdom Patent Application number 22 03 737.8, filed on 17 Mar. 2022. The whole contents of International Patent Application number PCT/GB2023/000015 and United Kingdom Patent Application number 22 03 737.8 are incorporated herein by reference.

### BACKGROUND OF THE INVENTION

The present invention relates to a force sensing device, a method of calibrating a force sensing device and a method of manufacturing a force sensing device.

Force sensing devices are commonly calibrated at the point of manufacture in order to correct for any differences in sensor response under load. During use, wear under repeat loading and/or changing environmental conditions over time, irreversible changes can occur within the sensing device.

Consequently, the initial calibration made during manufacture can be insufficient in order to maintain acceptable performance of the force sensing device throughout its useable lifetime.

Thus, there remains a need to maintain accurate force readings throughout the useable lifetime of the force sensing device.

### BRIEF SUMMARY OF THE INVENTION

According to a first aspect of the present invention, there is provided a force sensing device, comprising: a first electrode and a second electrode; said first electrode and said second electrode are arranged to provide an electrical output in response to an applied force to determine the magnitude of said applied force; said force sensing device further comprising: a collapsible structure configured to provide an electrical short circuit in response to said applied force when said applied force exceeds a predetermined magnitude.

According to a second aspect of the present invention, there is provided a method of calibrating a force sensing device, comprising the steps of: obtaining a force sensing device comprising a first electrode and a second electrode arranged to provide an electrical output in response to an applied force; and applying a force of a magnitude in excess of a predetermined magnitude to said force sensing device; wherein a collapsible structure arranged within said force sensing device provides an electrical short circuit in response to said applied force.

According to a third aspect of the present invention, there is provided a method of manufacturing a force sensing device, comprising the steps of: arranging a first electrode and a second electrode to form a force sensing device configured to provide an electrical output in response to an applied force; and arranging a collapsible structure within said force sensing device, said collapsible structure being configured to provide an electrical short circuit in response to said applied force when said applied force exceeds a predetermined magnitude.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art.

### BRIEF DESCRIPTION OF THE SEVERAL VIEWS OF THE DRAWINGS

FIG. 1 shows the different layers of a force sensing device;

FIG. 2 shows a cross-sectional schematic of a force sensing device in accordance with the invention;

FIG. 3 shows the force sensing device of FIG. 2 under application of an applied force;

FIG. 4 shows a force-resistance curve for a force sensing device; and

FIG. 5 shows a method of calibrating a force sensing device.

### DETAILED DESCRIPTION OF EMBODIMENTS OF THE INVENTION

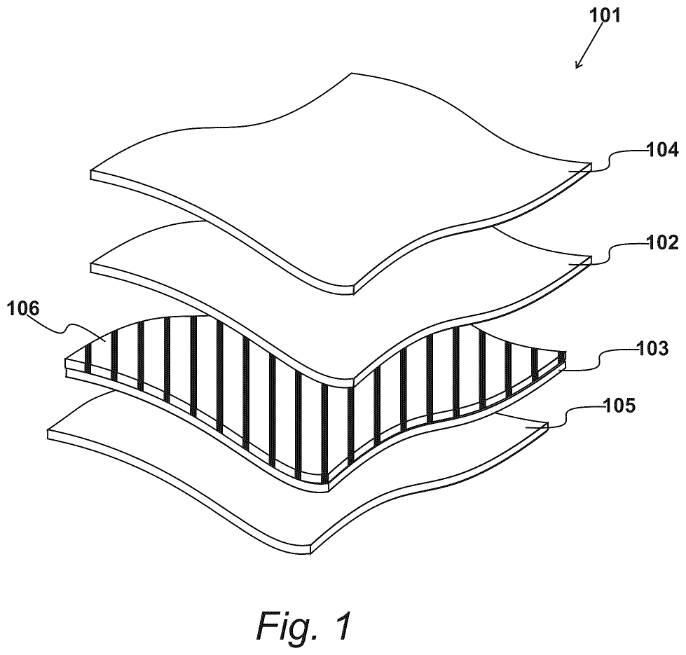

### FIG. 1

A force sensing device 101 is shown in FIG. 1 in an exploded schematic form illustrating the layers which make up the force sensing device. Force sensing device 101 comprises a first electrode 102 and a second electrode 103. In the embodiment, electrode 102 is provided on a first substrate 104 and electrode 103 is provided on a second substrate 105.

In an embodiment, electrode 102 comprises a first conductive layer and electrode 103 comprises a second conductive layer. In an embodiment, the conductive layers comprise a metallic material such as a silver-based ink or a carbon-based ink coated on the respective substrate.

Additionally, in the embodiment, at least one of the electrodes further comprises a resistive material layer 106 which may be coated on a surface of the conductive layer or conductive layers. In this illustrated embodiment, resistive material layer is shown coated on electrode 103. It is appreciated that, in alternative embodiments, resistive material layer 106 may be coated on electrode 102 or both electrodes 102 and 103. In an embodiment, the resistive material layer comprises a quantum tunnelling material, for example, a quantum tunnelling composite material available from the applicant, Peratech Holdco Ltd, under the trade mark QTC®. The resistive material layer therefore comprises a material which shows a change in resistance in response to an applied force. It is appreciated that other materials having variable resistance may be utilized in the present invention.

In combination, electrode 102 and electrode 103 are arranged to provide an electrical output in response to an applied force to enable determination of the magnitude of such an applied force. In some embodiments, in addition to the magnitude of the applied force, electrodes 102 and 103 may be further configured to determine positional data in relation to the applied force.

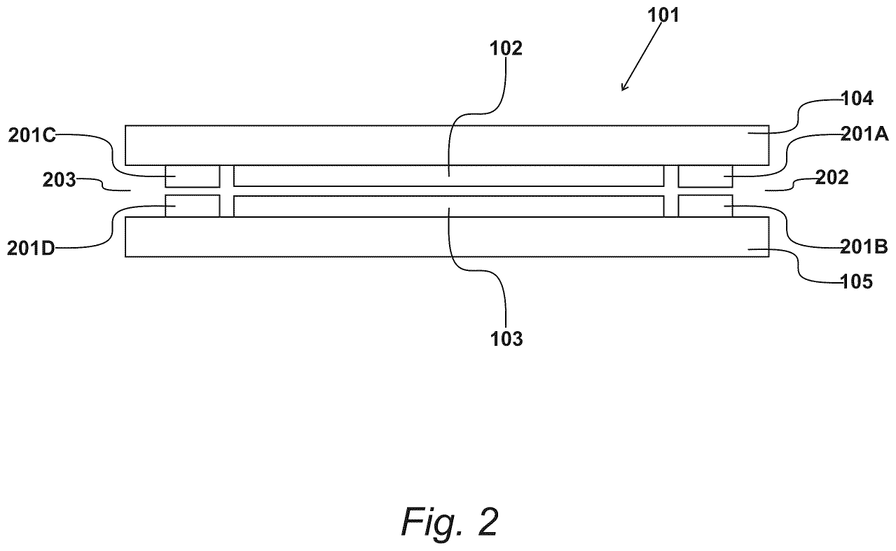

### FIG. 2

A cross-sectional schematic of force sensing device 101 is shown further in FIG. 2.

In the embodiment, force sensing device 101 further comprises a collapsible structure 201. Collapsible structure 201 comprises electrical shorting contacts and is configured to provide an electrical short circuit in response to an applied force if the applied force exceeds a predetermined magnitude.

In this illustrated embodiment, collapsible structure 106 comprises four separate elements 201A, 201B, 201C and 201D. As shown, elements 201A and 201C are arranged on substrate 104 and elements 201B and 201D are arranged on substrate 105. In the embodiment, collapsible structure 201 is positioned an end of substrates 104 and 105. Thus, elements 201A and 201B are arranged at a first end 202 of force sensing device 101 and elements 201C and 201D are arranged at a second end 203 of force sensing device 101. It is appreciated that however, alternative collapsible structures may be positioned elsewhere in the force sensing device where they are able to receive an applied force for calibration purposes.

In the embodiment, collapsible structure 201 comprises a metallic based contact which is configured to provide an electrical short circuit. In an alternative embodiment, collapsible structure 201 comprises a domed structure arranged to form an electro-mechanical switch. In one such embodiment, the domed structure comprises an elastic material that collapses under an applied force of a predetermined magnitude which causes the electrodes to respond leading to a shorting of the measurement of applied force from the electrodes.

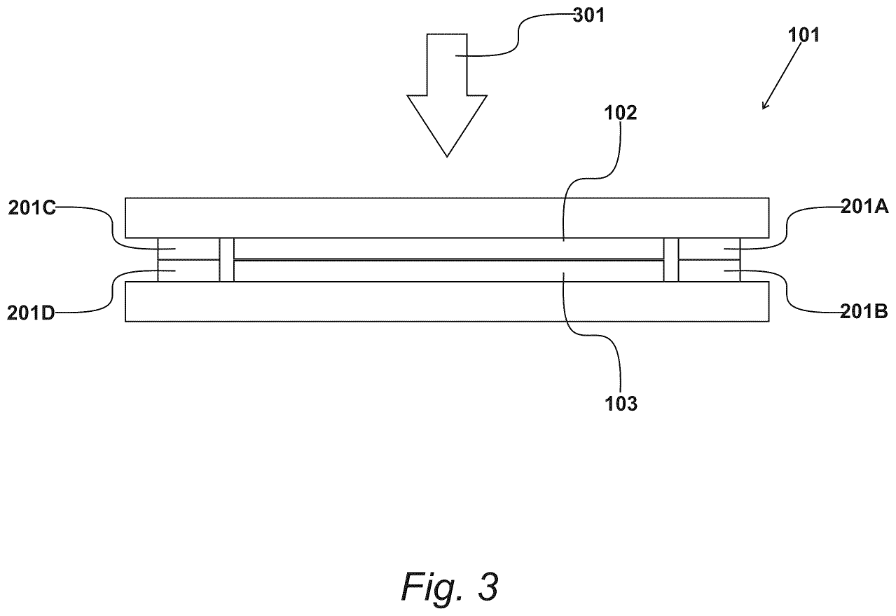

FIG. 2 shows the collapsible structure 201 in an initial configuration in which elements 201A and 201B and 201C and 201D are out of contact with each other in a similar way to electrodes 102 and 103. Under an applied force, which will be described further with respect to FIG. 3, collapsible structure 201 is configured to transform into a collapsed configuration in response to the applied force.

### FIG. 3

In the embodiment shown in FIG. 3, an applied force 301 is provided to an upper surface of force sensing device 101. Applied force 301 has the effect of bringing electrode 102 and electrode 103 into contact with each other to allow a flow of current between the two electrodes such that a magnitude of force applied can be calculated in a conventional manner.

At the same time, with force sensing device 101, collapsible structure 201 further receives the input of applied force 301 and deforms into a collapsed configuration relative to the initial configuration of FIG. 2. 10

In the embodiment, collapsible structure 201 comprises a plurality of contact elements made from a material having a contact radius which is configured to expand under an applied force. An example of such a material comprises a silver-based contact material. Thus, in this embodiment, elements 201A, 201B, 201C and 201D expand in cross-sectional area in response to applied force 301. Consequently, when a given contact radius is reached, corresponding to a force of predetermined magnitude, collapsible structure provides an electrical short circuit.

Thus, a single output signal from the electrical short circuit is provided at a known, predetermined force of a given magnitude. The electrical short circuit may be reported in a main sensing circuit of the force sensing device or electronic device in which force sensing device is incorporated. If the short circuit occurs in the main sensing circuit, the collapse force can be designed to be at an upper limit of the sensing force range of the force sensing device, so as to not impair sensing functionality at lower forces. 25

Alternatively, separate circuitry may be provided which receives the short circuit.

In the embodiment, collapsible structure 201 is configured to return from the collapsed configuration of FIG. 3 to the initial configuration of FIG. 2. This return to the initial configuration is designed to be repeatable such that the force sensing device can be calibrated repeatably throughout its life cycle.

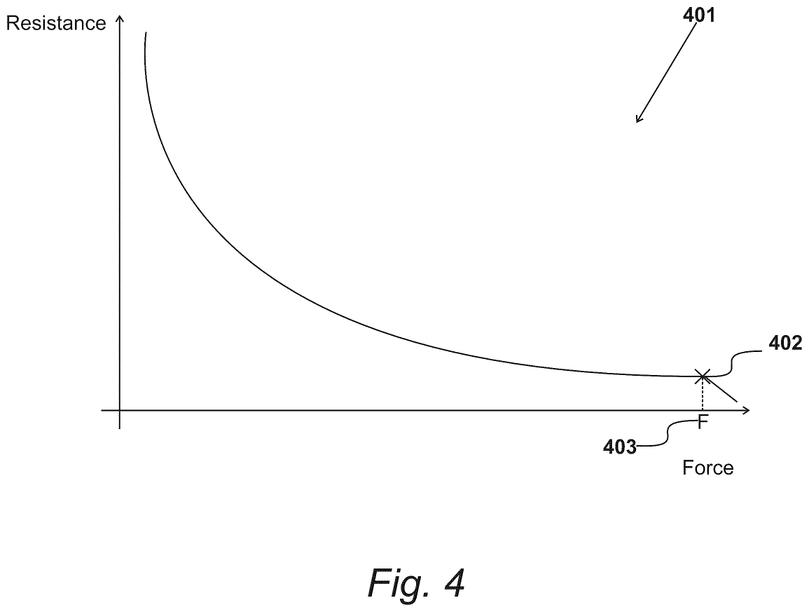

### FIG. 4

A force resistance curve 401 for a force sensing device is shown in FIG. 4. Force-resistance curve 401 shows a typical response to applied force for a force sensing device such as force sensing device 101.

In an example embodiment, the collapsible structure is configured to short the electrical contacts so that the measure of resistance in the sensing circuit provides a sudden change in resistance identified in the sensing circuitry. As illustrated, at a point 402, an applied force 403 of magnitude F is reached. At this point, a sudden change of resistance is experienced due to the collapse of collapsible structure 201. Consequently, the sensing circuitry is able to utilize the change in resistance at point 402 as a reference point for the predetermined force. The resistance values measured prior to point 402 can then be utilized as values in a calibration. This thereby reduces any prior force error.

In an example embodiment, force F is configured to be of a magnitude outside ordinary use, such as at an upper limit. Thus, the force sensing device may be provided with a calibration routine which a user may activate at given intervals to recalibrate the force sensing device over its life cycle.

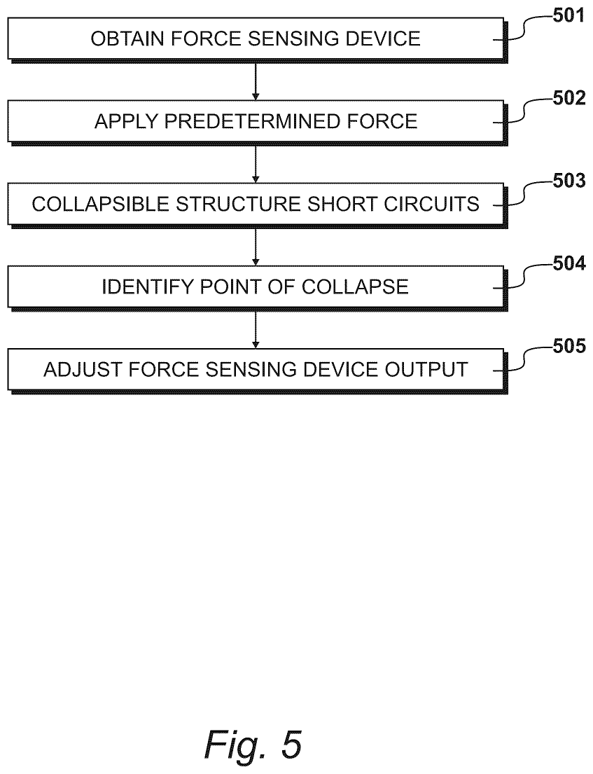

### FIG. 5

A method of calibrating a force sensing device as described herein is shown schematically in FIG. 5. At step 501 a force sensing device, such as force sensing device 101 is obtained. The force sensing device, as described previously comprises a first electrode and a second electrode arranged to provide an electrical output in response to an applied force.

On application of the applied force of predetermined magnitude, or an excess of the applied force, at step 502, collapsible structure 201 causes a short circuit in response to the applied force at step 503.

Sensing circuitry and a corresponding processor then uses the data from the short circuit to identify a point of collapse at step 504. In an embodiment, the step of identifying the point of collapse of the collapsible structure is identified by means of a change in electrical resistance.

Accordingly, at step 505, the force sensing device is adjusted or recalibrated to ensure that future outputs have any prior errors reduced.

The invention claimed is:

1. A force sensing device, comprising:
a first electrode and a second electrode;
said first electrode and said second electrode are arranged to provide an electrical output in response to an applied force to determine a magnitude of said applied force;
said force sensing device further comprising:
a collapsible structure configured to provide an electrical short circuit in response to said applied force when said applied force exceeds a predetermined magnitude.

2. The force sensing device of claim 1, wherein said first electrode comprises a first conductive layer and said second electrode comprises a second conductive layer.

3. The force sensing device of claim 2, wherein at least one of said first electrode or said second electrode further comprises a variably resistive material layer.

4. The force sensing device of claim 1, wherein said first electrode is provided on a first substrate and said second electrode is provided on a second substrate.

5. The force sensing device of claim 1, wherein said collapsible structure is configured to return to an initial configuration from a collapsed configuration following application of said applied force exceeding said predetermined magnitude.

6. The force sensing device of claim 1, wherein said collapsible structure is configured to expand in cross-sectional area in response to said applied force.

7. A method of calibrating a force sensing device, comprising the steps of:
obtaining a force sensing device comprising a first electrode and a second electrode arranged to provide an electrical output in response to an applied force; and
applying a force of a magnitude in excess of a predetermined magnitude to said force sensing device; wherein
a collapsible structure arranged within said force sensing device provides an electrical short circuit in response to said applied force.

8. The method of claim 7, wherein said electrical short circuit provides a change in electrical resistance, said method further comprising the step of:
identifying a point of collapse of said collapsible structure by means of said change in electrical resistance.

9. The method of claim 8, further comprising the step of:
adjusting an output of said force sensing device in response to said step of identifying a point of collapse.

10. A method of manufacturing a force sensing device, comprising the steps of:
arranging a first electrode and a second electrode to form a force sensing device configured to provide an electrical output in response to an applied force; and
arranging a collapsible structure within said force sensing device, said collapsible structure being configured to provide an electrical short circuit in response to said applied force when said applied force exceeds a predetermined magnitude.

11. The method of claim 10, further comprising the step of:
providing said first electrode to a first substrate; and
providing said second electrode to a second substrate.

12. The method of claim 10, further comprising the step of:
applying a variably resistive material to said first electrode or said second electrode.
